(19) United States
(12) Patent Application Publication
(10) Pub. No.: US 2013/0282203 A1
(43) Pub. Date: Oct. 24, 2013

(54) Remote Control System for Vehicle

(71) Applicant: Dawei Wang, Fremont, CA (US)

(72) Inventor: Dawei Wang, Fremont, CA (US)

(21) Appl. No.: 13/917,547

(22) Filed: Jun. 13, 2013

(51) Int. Cl. G06F 17/00

(52) U.S. Cl. CPC G06F 17/00
USPC 701/2

(57) ABSTRACT

A remote control system includes a first transceiver installed in a vehicle and a remote controller, wherein the remote controller having a second transceiver for wirelessly connecting with the first transceiver. An interaction and control module is operatively connecting to the second transceiver so as to transmit said operating signals therefrom, and a distance calibration module is operatively connecting to the interaction and control module so as to compute the distance between the first transceiver and the second transceiver. A location recording module is operatively connecting to the interaction and control module so as to record the location of the vehicle, and a distance display indicator operatively connecting to the interaction and control module so as to display location and operating motion of the vehicle. A voice display indicator is operatively connecting to the interaction and control module so as to determine the location of the vehicle.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a remote control system, more particularly to the remote control built-in transceiver for vehicle, wherein the remote control is capable to receive and send control signals in order to locating vehicle.

2. Description of Related Arts

Most people have the unpleasant experience of finding their car in the parking lot due to forgetting where they park their car. An user usually uses a remote controller to determine where the location of the user's car is, but it is usually invalid for long-distance.

A conventional remote control system, such as automobile remote control system, comprises a transmitter installed on a remote controller and a receiver installed on a vehicle wirelessly connecting with the transmitter. The conventional remote control system is able to transmit the operating signal from the transmitter to receiver, and then operates the lock and unlock motion. However, the conventional remote control system has several drawbacks. The conventional remote control system is unable to determine not only the distance between the transmitter and the receiver, but also the location of the user's car is. In addition, the conventional remote control system is restricted to operates the lock and unlock motion only.

In order to solve the above mentioned problem, a remote control system with built-in transceiver is needed so that the user is able to determine the location of his/her car. Otherwise, the distance indicator must be employed to the remote control system so as to display motion of the vehicle.

### SUMMARY OF THE PRESENT INVENTION

A main object of the present invention is to provide a remote control system with a vehicle built-in transceiver for locating the vehicle, wherein the remote control function as a two-way communication device not only sends an operating signal to the vehicle, but also receive a feedback therefrom to the remote control.

Another object of the present invention is to provide a remote control system with a vehicle built-in transceiver for locating the vehicle, wherein the transceiver is operatively linking with a distance calibration module through an interaction and control module so as to compute the distance between the transceiver and the vehicle.

Another object of the present invention is to provide a remote control system with a vehicle built-in transceiver for locating the vehicle, wherein the transceiver is operatively linking with a location recording module so as to record the location of the vehicle.

Another object of the present invention is to provide a remote control system with a vehicle built-in transceiver for locating vehicle, wherein the remote control system is adapted to incorporate with a distance display indicator, such as visual and voice indicator, for facilitating the user to determine the location of his/her vehicle and the operating motion.

Accordingly, in order to accomplish the above objects, the present invention provides a remote control system for a vehicle which includes a first transceiver adapted for installing in the vehicle and a remote controller, wherein the remote controller having a second transceiver for wirelessly connecting with the first transceiver. An interaction and control module is operatively connecting to the second transceiver so as to transmit said operating signals therefrom, and a distance calibration module is operatively connecting to the interaction and control module so as to compute the distance between the first transceiver and the second transceiver. A location recording module is operatively connecting to the interaction and control module so as to record the location of the vehicle, and a distance display indicator operatively connecting to the interaction and control module so as to display location and operating motion of the vehicle. A voice display indicator is operatively connecting to the interaction and control module so as to determine the location of the vehicle.

These and other objectives, features, and advantages of the present invention will become apparent from the following detailed description, the accompanying drawings, and the appended claims.

### BRIEF DESCRIPTION OF THE DRAWINGS

FIG. 1 is a diagram of the remote control system with built-in transceivers and remote controller for vehicle according to a preferred embodiment of the present invention, illustrating how the remote controller incorporating the transceiver.

FIG. 2 is a diagram of three operating signal generating from the interaction and control module according to the above preferred embodiment of the present invention.

FIG. 3 is a diagram of a distance display indicator incorporating with the interaction and control module according to the above preferred embodiment of the present invention.

FIG. 4 is a diagram of a voice display indicator incorporating with the interaction and control module according to the above preferred embodiment of the present invention.

### DETAILED DESCRIPTION OF THE PREFERRED EMBODIMENT

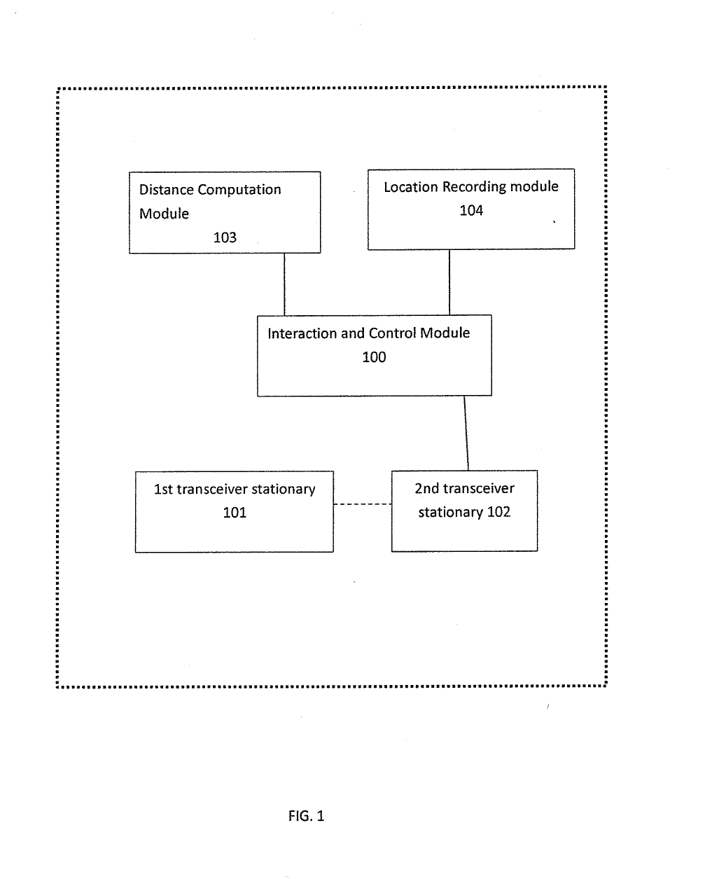

Referring to FIG. 1, a remote control system for vehicle comprises a first transceiver stationary installed in a remote object such as a vehicle and a remote controller, wherein the remote controller having a second transceiver 102 wireless communicating with the first transceiver 101.

The remote controller further comprises an interaction and control module 100 adapted for operatively connecting to the second transceiver 102 so as to transmit operating signals therefrom, a location recording module 104 operatively connecting with the interaction and control module 100 for receiving a location signal, and a distance calibration module 103 operatively connecting with the interaction and control module 100 for receiving a calibrating signal.

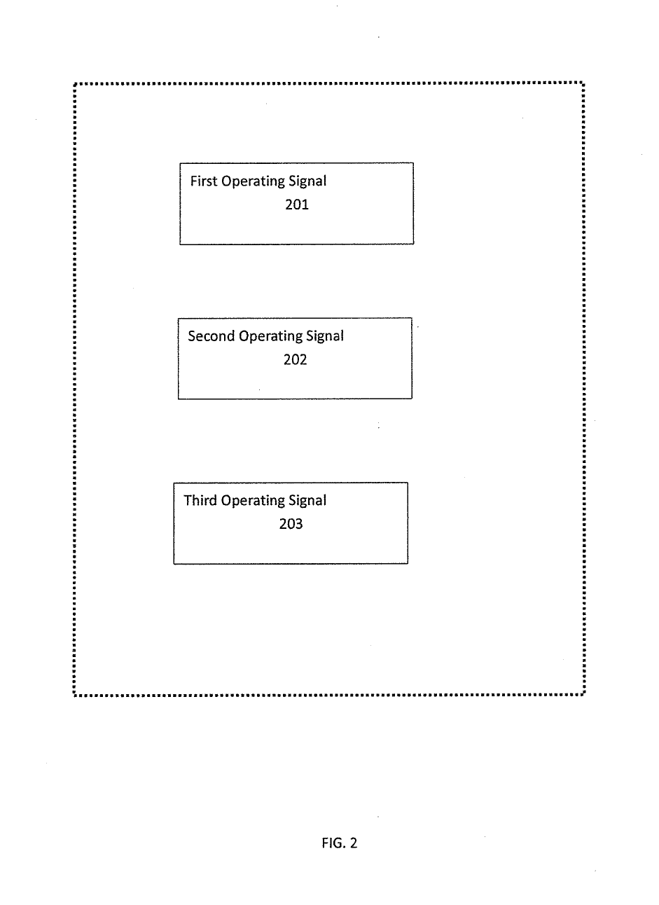

Referring to FIGS. 1 to 2, the interaction and control module 100 is arranged to generate a first operating signal 201, a second operating signal 202, and a third operating signal 203. The second transceiver 102 is adapted to transmit the first, second and third operating signals 201, 202, 203 from the interaction and control module 100 so as to sending the above three signals to the first transceiver 101.

In other words, the lock motion is being activated by the first transceiver stationary 101 for receiving the first operating signal, at the same time, and the first transceiver 101 generates a first feedback signal, the location recording signal, and sending back to the second transceiver 102. That is to say, the unlock motion is being activated by the first transceiver 101 for receiving the second operating signal, and then the first transceiver 101 generates a second feedback signal, a distance calibrating signal, sending back to the second transceiver 102. In addition, the second feedback signal is also generated when the third operating signal is being received by the first transceiver 101.

Accordingly, the first feedback signal and the second feedback signal are able to transmit to the interaction and control module 100 from the second transceiver 102, so as to transmit the first feedback signal to the location record module 104 and transmit the second feedback signal to the distance calibration module 103. The location record module 104 is arranged to storage the first feedback signal so as to recognize the parking space number and the geographic location of the parking lot. The distance calibration module 103 is arranged to calibrate the second feedback signal so as to compute the distance between the first transceiver 101 and the second transceiver stationary 102.

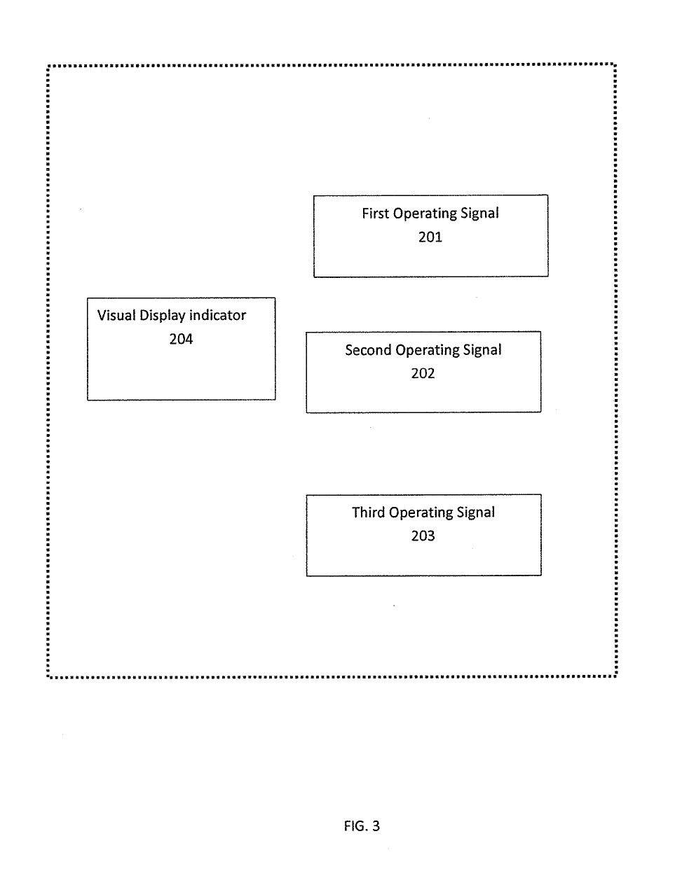

Referring to FIG. 3, the interaction and control module 100 further comprises a distance display indicator 204 which is driven to display the location distance between the first transceiver stationary and the second transceiver stationary and further driven to display the lock motion by the interaction and control module 100 through receiving the first feedback signal.

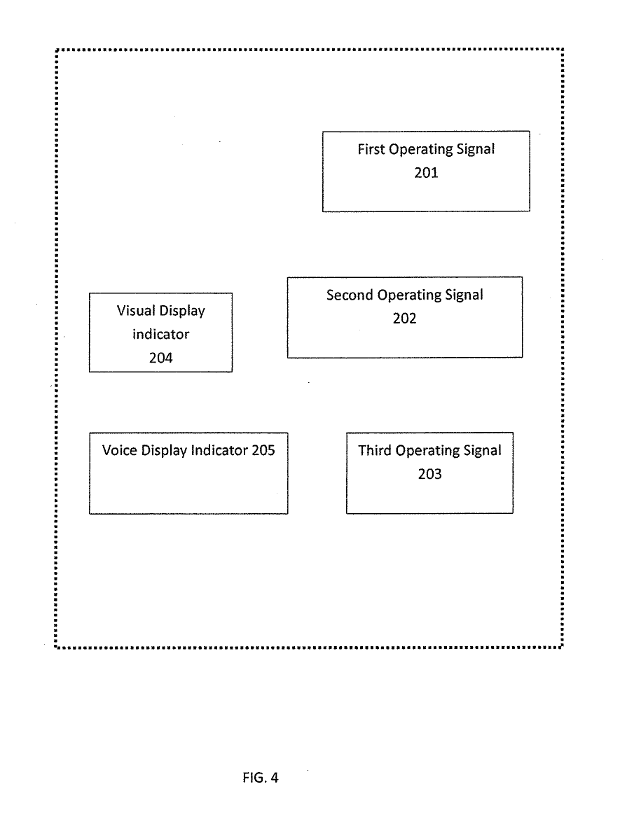

Referring to FIG. 4, the interaction and control module 100 further comprises a voice display indicator 205 which is driven to generate the beep sound by the interaction and control module 100 through receiving the second feedback signal. The beep sound gradually increase when the first transceiver 101 approaching the second transceiver 102.

By means of the remote control system as described above, a vehicle can be located through a method comprising the following steps:

(a) providing the first transceiver in the vehicle;

(b) wirelessly communicating the first transceiver with the second transceiver contained in the remote controller;

(c) transmitting operating signals from the second transceiver by the interaction and control module;

(d) computing a distance between said first transceiver and said second transceiver by mean of the distance calibration module;

(e) recording a location of the vehicle by means of the location recording module; and

(f) displaying location and operating motion of the vehicle via a displaying means which is operatively connected to the interaction and control module.

According to the preferred embodiment, the displaying means includes the distance display indicator displaying location and operating motion of the vehicle and the voice display indicator determining the location of the vehicle.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A remote control system for a vehicle, comprising:
a first transceiver adapted for installing in the vehicle; and
a remote controller which comprises:
a second transceiver wirelessly communicating with said first transceiver;
an interaction and control module operatively connecting to said second transceiver so as to transmit said operating signals therefrom;
a distance calibration module operatively connecting to said interaction and control module so as to compute the distance between said first transceiver and said second transceiver;
a location recording module operatively connecting to said interaction and control module so as to record the location of the vehicle; and
means for displaying location and operating motion of the vehicle.

2. The remote control system, as recited in claim 1, wherein said displaying means includes a distance display indicator operatively connecting to said interaction and control module so as to display location and operating motion of the vehicle.

3. The remote control system, as recited in claim 1, wherein said displaying means includes a voice display indicator operatively connecting to said interaction and control module so as to determine the location of the vehicle.

4. The remote control system, as recited in claim 2, wherein said displaying means further includes a voice display indicator operatively connecting to said interaction and control module so as to determine the location of the vehicle.

5. The remote control system, as recited in claim 1, wherein said first transceiver and said second transceiver are an infrared transceiver to transmit an infrared signal.

6. The remote control system, as recited in claim 4, wherein said first transceiver and said second transceiver are an infrared transceiver to transmit an infrared signal.

7. The remote control system, as recited in claim 1, wherein said interaction and control module generates a first operating signal to control the motion of lock, a second operating signal to control the motion of unlock, and a third operating signal.

8. The remote control system, as recited in claim 4, wherein said interaction and control module generates a first operating signal to control the motion of lock, a second operating signal to control the motion of unlock, and a third operating signal.

9. The remote control system, as recited in claim 6, wherein said interaction and control module generates a first operating signal to control the motion of lock, a second operating signal to control the motion of unlock, and a third operating signal.

10. The remote control system, as recited in claim 9, wherein said interaction and control module is operatively incorporated with a visual display indicator to display the location of the vehicle.

11. The remote control system, as recited in claim 10, wherein said distance display indicator is able to display a lock motion of the vehicle.

12. The remote control system, as recited in claim 9, wherein said interaction and control module is operatively incorporated with a voice display indicator which is able to generate the beep sound gradually increasing when said first transceiver approaching said second transceiver.

13. A method for locating a vehicle, comprising the steps of:
(a) providing a first transceiver in the vehicle and a remote controller
(b) wirelessly communicating said first transceiver with a second transceiver contained in a remote controller;
(c) transmitting operating signals from said second transceiver by an interaction and control module which is operatively connected to said second transceiver;
(d) computing a distance between said first transceiver and said second transceiver by mean of a distance calibration module which is operatively connected to said interaction and control module;
(e) recording a location of the vehicle by means of a location recording module which is operatively connected to said interaction and control module; and
(f) displaying location and operating motion of the vehicle via a displaying means which is operatively connected to said interaction and control module.

14. The method, as recited in claim 13, wherein said displaying means includes a distance display indicator displaying location and operating motion of the vehicle and a voice display indicator determining the location of the vehicle.

15. The method, as recited in claim 14, wherein said first transceiver and said second transceiver are an infrared transceiver to transmit an infrared signal.

16. The method, as recited in claim 14, wherein said interaction and control module generates a first operating signal to control the motion of lock, a second operating signal to control the motion of unlock, and a third operating signal.

17. The method, as recited in claim 16, wherein said interaction and control module is operatively incorporated with a visual display indicator to display the location of the vehicle.

18. The method, as recited in claim 17, wherein said distance display indicator is able to display the lock motion of the vehicle.

19. The method, as recited in claim 16, wherein said interaction and control module is operatively incorporated with a voice display indicator which is able to generate the beep sound gradually increasing when the first transceiver approaching the second transceiver.

20. The method, as recited in claim 18, wherein said interaction and control module is operatively incorporated with a voice display indicator which is able to generate the beep sound gradually increasing when the first transceiver approaching the second transceiver.
